(19) United States
(12) Patent Application Publication
(10) Pub. No.: US 2025/0229333 A1
(43) Pub. Date: Jul. 17, 2025

(54) SYSTEMS AND METHODS FOR SMOOTHING A CONTOUR OF AN OBJECT FORMED DURING ADDITIVE MANUFACTURING

(71) Applicant: General Electric Company, Schenectady, NY (US)

(72) Inventors: Brian S. McCarthy, Ballston Lake, NY (US); Christina Vasil, Cohoes, NY (US); Russell R. Dennison, Glenville, NY (US); John J. Madelone, South Glens Falls, NY (US); Laxmi Poudel, Clifton Park, NY (US)

(73) Assignee: General Electric Company, Schenectady, NY (US)

(21) Appl. No.: 18/414,521

(22) Filed: Jan. 17, 2024

(51) Int. Cl. B22F 10/366; B22F 10/28; B22F 10/85; B22F 12/41; B22F 12/45; B22F 12/49; B22F 12/90; B33Y 10/00; B33Y 30/00; B33Y 50/02

(52) U.S. Cl. CPC B22F 10/366; B22F 10/28; B22F 10/85; B22F 12/41; B22F 12/45; B22F 12/49; B22F 12/90; B33Y 10/00; B33Y 30/00; B33Y 50/02

(57) ABSTRACT

An additive manufacturing system including laser devices and laser scanning devices. The laser devices including first and second laser devices configured to generate first and second laser beams for consolidating a solid component, respectively. The laser scanning devices including first and second laser scanning devices configured to selectively direct the first and second laser beams across a powder bed along first and second plurality of laser beam paths to define a plurality of first and second hatching paths and portions of first and second contour paths. The first contour path partially defining a contour of a first portion the solid component, and the second contour path partially defining a contour of a second portion of the solid component. The first contour path defines a first hook extending into the second contour path.

### TECHNICAL FIELD

The present specification generally relates to additive manufacturing systems and, more specifically, systems and methods for smoothing a contour of an object formed during additive manufacturing.

### BACKGROUND

At least some additive manufacturing systems involve the buildup of a powdered material to make a component. These techniques can produce complex components from powder materials at a reduced cost and with improved manufacturing efficiency. At least some known additive manufacturing systems, such as DMLM systems, fabricate components using a plurality of laser devices, a build platform, a recoater, and a powder material, such as, without limitation, a powdered metal. The laser devices each generate a laser beam that melts the powder material on the build platform in and around the area where the laser beam is incident on the powder material, resulting in a melt pool. The melt pool cools into a consolidated, solid top layer of the component. Multiple portions of the component may be manufactured simultaneously using multiple lasers. As such, multiple lasers reduce manufacturing time and reduce the cost to produce the component.

The laser beams must be aligned during the manufacturing process to ensure that the portions manufactured by each individual laser beam are aligned throughout the manufacturing process. Errors and/or misalignments may develop within the component if the laser beams become misaligned during the manufacturing process. Specifically, the contours, or outer surface, of the component may be misaligned if the laser beams are misaligned. This misalignment may cause steps, or sharp raised portions and/or sharp corners, on the contours of the component that are supposed to be continuous and smooth. Typically, the laser beams are calibrated or aligned before the manufacturing process, and it is assumed that the laser beams remain aligned throughout the process. However, the laser beams may become misaligned during the manufacturing process and result in misalignment of the contours of the component.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an additive manufacturing system including multiple lasers, according to one or more embodiments shown and described herein;

FIG. 2 schematically depicts a side view of a solid component formed using the additive manufacturing system of FIG. 1, according to one or more embodiments shown and described herein;

FIG. 3 schematically depicts a cross-sectional top view of the solid component of FIG. 2 taken along line 3-3 of FIG. 2, according to one or more embodiments shown and described herein;

FIG. 4 schematically depicts a side view of another solid component formed using the additive manufacturing system of FIG. 1, according to one or more embodiments shown and described herein;

FIG. 5 schematically depicts a side view of another solid component formed using the additive manufacturing system of FIG. 1, according to one or more embodiments shown and described herein;

FIG. 6 schematically depicts a side view of another solid component formed using the additive manufacturing system of FIG. 1, according to one or more embodiments shown and described herein;

FIG. 7 schematically depicts a side view of another solid component formed using the additive manufacturing system of FIG. 1, according to one or more embodiments shown and described herein;

FIG. 8 schematically depicts a partial side view of another solid component including contour paths having rounded portions, according to one or more embodiments shown and described herein;

FIG. 9 schematically depicts a top view of another solid component including contour paths extending in an XY plane, according to one or more embodiments shown and described herein; and

FIG. 10 depicts a flow diagram of a method for manufacturing a solid component with an additive manufacturing system, according to one or more embodiments shown and described herein.

### DETAILED DESCRIPTION

Embodiments of the additive manufacturing systems described herein utilize hooks at the end of contour paths to reduce the roughness of a contour of a solid component. The additive manufacturing system includes at least two laser devices and at least two laser scanning devices. The laser devices include a first laser device configured to generate a first laser beam and a second laser device configured to generate a second laser beam. The first laser beam is configured to consolidate a first portion of a solid component, and the second laser beam is configured to consolidate a second portion of the solid component. The laser scanning devices include a first laser scanning device and the second laser scanning device. The first laser scanning device is configured to direct the first laser beam from the first laser devices across a powder bed along a plurality of first laser beam paths defining a plurality of first hatching paths and a portion of at least one first contour path along a contour of the first portion of the solid component. The second laser scanning device is configured to direct the second laser beam from the second laser device across the powder bed along a plurality of second laser beam paths defining a plurality of second hatching paths and a portion of at least one second contour path along a contour of the second portion of the solid component. When the scanning devices become misaligned, the first contour path and the second contour path also become misaligned, creating a discontinuity on a surface of the solid component. The discontinuity causes roughness on the surface of the solid component. A hook is formed within the first and second contour paths in order to stitch the first and second portions of the solid component together and reduce the roughness caused by misalignment of the scanning devices and/or laser beams. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

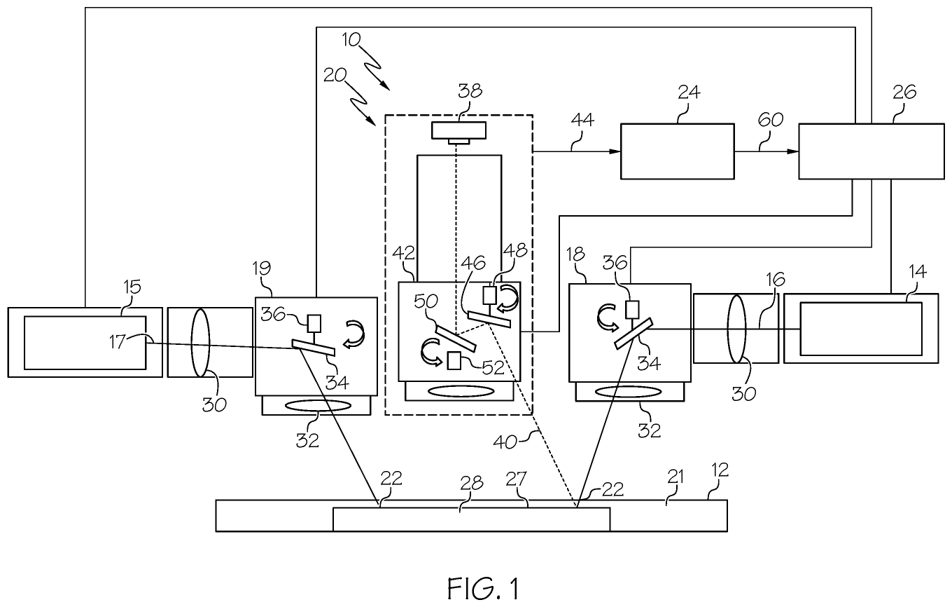

Referring now to FIG. 1, an additive manufacturing system 10 illustrated in the form of a direct metal laser melting (DMLM) system. Although the embodiments herein are described with reference to a DMLM system, this disclosure also applies to other types of additive manufacturing systems, such as selective laser sintering systems.

In embodiments, the DMLM system 10 includes a build platform 12, a first and second laser devices 14, 15 configured to generate first and second laser beams 16, 17, first and second laser scanning devices 18, 19 configured to selectively direct the laser beams 16, 17 across the build platform 12, and an optical system 20 for monitoring a melt pool 22 created by the laser beams 16, 17. The DMLM system 10 further includes a computing device 24 and a controller 26 configured to control one or more components of the DMLM system 10, as described in more detail herein.

In embodiments, a powdered build material 21 includes materials suitable for forming a solid component 28, including, without limitation, gas atomized alloys of cobalt, iron, aluminum, titanium, nickel, and combinations thereof. In other embodiments, the powdered build material 21 includes any suitable type of powdered build material. In other embodiments, the powdered build material 21 includes any suitable build material that enables the DMLM system 10 to function as described, including, for example, ceramic powders, metal-coated ceramic powders, and thermoset or thermoplastic resins. The powdered build material 21 is spread across the build platform 12 to form a powdered bed 27. The powdered build material 21 within the powdered bed 27 is then melted and re-solidified during the additive manufacturing process to build a solid component 28 on the build platform 12.

As shown in FIG. 1, each laser device 14, 15 is configured to generate a respective laser beam 16, 17 of sufficient energy to at least partially melt the powdered build material 21 of the build platform 12. In embodiments, the laser devices 14, 15 are a yttrium-based solid state laser configured to emit a laser beam having a wavelength of about 1070 nanometers (nm). In other embodiments, the laser devices 14, 15 include any suitable type of laser that enables the DMLM system 10 to function as described herein such as, for example, a carbon dioxide laser. Further, although the DMLM system 10 is shown and described as including two laser devices 14, 15, the DMLM system 10 may include any number and combination of laser devices that enable the DMLM system 10 to function as described herein including, without limitation, three, four, five, or more than five laser devices. In embodiments, for example, the DMLM system 10 includes a first laser device 14 having a first power output and a second laser device 15 having a second power output different from the first laser power output, or at least two laser devices having substantially the same power output.

The laser devices 14, 15 are optically coupled to the optical elements 30 and 32 that facilitate focusing the laser beams 16, 17 on the build platform 12. In embodiments, the optical elements 30, 32 include a beam collimator 30 disposed between the laser devices 14, 15 and the laser scanning devices 18, 19, and an F-theta lens 32 disposed between the laser scanning devices 18, 19 and the build platform 12. In other embodiments, the DMLM system 10 includes any suitable type and arrangement of optical elements that provide a collimated and/or focused laser beam on the build platform 12.

The laser scanning devices 18, 19 are configured to direct the laser beams 16, 17 across selective portions of the build platform 12 to create the solid component 28. In embodiments, the laser scanning devices 18, 19 are galvanometer scanning devices including a mirror 34 operatively coupled to a galvanometer-controlled motor 36 such as, for example, an actuator. The motor 36 is configured to move such as, for example, rotate, the mirror 34 in response to signals received from the controller 26, and thereby deflect the laser beams 16, 17 across selective portions of the build platform 12. The mirror 34 includes any suitable configuration that enables the mirror 34 to deflect the laser beams 16, 17 towards the build platform 12. In embodiments, the mirror 34 includes a reflective coating that has a reflectance spectrum that corresponds to the wavelength of the laser beams 16, 17.

Although the laser scanning devices 18, 19 are illustrated with a single mirror 34 and a single motor 36, the laser scanning devices 18, 19 may include any suitable number of mirrors and motors that enable the laser scanning devices 18, 19 to function as described herein. In embodiments, the laser scanning devices 18, 19 each includes two mirrors and two galvanometer-controlled motors, each operatively coupled to one of the mirrors. In other embodiments, the laser scanning devices 18, 19 include any suitable scanning device that enables the DMLM system 10 to function as described herein, such as, for example, two-dimension (2D) scan galvanometers, three-dimension (3D) scan galvanometers, and dynamic focusing galvanometers.

The optical system 20 is configured to detect electromagnetic radiation generated by the melt pool 22 and transmit information about the melt pool 22 to the computing device 24. Specifically, the optical system 20 detects the location of the laser beams 16, 17 in the melt pool 22. In embodiments, the optical system 20 includes a first optical detector 38 configured to detect electromagnetic radiation 40 generated by the melt pool 22, and an optical scanning device 42 configured to direct the electromagnetic radiation 40 to the first optical detector 38. More specifically, the first optical detector 38 is configured to receive the electromagnetic radiation 40 generated by the melt pool 22 and generate an electrical signal 44 in response thereto. The first optical detector 38 is communicatively coupled to the computing device 24 and is configured to transmit the electrical signal 44 to the computing device 24.

The first optical detector 38 includes any suitable optical detector that enables the optical system 20 to function as described herein, including, for example, a photomultiplier tube, a photodiode, an infrared camera, a charged-couple device (CCD) camera, a CMOS camera, a pyrometer, or a high-speed visible-light camera. Although the optical system 20 is shown and described herein as including a single first optical detector 38, the optical system 20 may include any suitable number and type of optical detectors that enables the DMLM system 10 to function as described herein. In embodiments, the optical system 20 includes a first optical detector configured to detect electromagnetic radiation within an infrared spectrum, and a second optical detector configured to detect electromagnetic radiation within a visible-light spectrum. In embodiments including more than one optical detector, the optical system 20 includes a beam splitter configured to divide and deflect the electromagnetic radiation 40 from the melt pool 22 to a corresponding optical detector.

While the optical system 20 is described as including “optical” detectors for the electromagnetic radiation 40 generated by the melt pool 22, it should be noted that use of the term “optical” is not to be equated with the term “visible.” Rather, the optical system 20 is configured to capture a wide spectral range of electromagnetic radiation. For example, the first optical detector 38 is sensitive to light with wavelengths in the ultraviolet spectrum (about 200-400 nm), the visible spectrum (about 400-700 nm), the near-infrared spectrum (about 700-1,200 nm), and the infrared spectrum (about 1,200-10,000 nm). Further, because the type of electromagnetic radiation emitted by the melt pool 22 depends on the temperature of the melt pool 22, the optical system 20 is capable of monitoring and measuring both a size and a temperature of the melt pool 22.

The optical scanning device 42 is configured to direct the electromagnetic radiation 40 generated by the melt pool 22 to the first optical detector 38. In embodiments, the optical scanning device 42 is a galvanometer scanning device including a first mirror 46 operatively coupled to a first galvanometer-controlled motor 48 such as, for example, an actuator, and a second mirror 50 operatively coupled to a second galvanometer-controlled motor 52 such as, for example, an actuator. The first motor 48 and the second motor 52 are configured to move such as, for example, rotate, the first mirror 46 and the second mirror 50, respectively, in response to signals received from the controller 26 to deflect the electromagnetic radiation 40 from the melt pool 22 to the first optical detector 38. The first mirror 46 and the second mirror 50 have any suitable configuration that enables the first mirror 46 and the second mirror 50 to deflect the electromagnetic radiation 40 generated by the melt pool 22. In embodiments, one or both of the first mirror 46 and the second mirror 50 includes a reflective coating that has a reflectance spectrum that corresponds to electromagnetic radiation that the first optical detector 38 is configured to detect.

Although the optical scanning device 42 is illustrated and described herein as including two mirrors and two motors, the optical scanning device 42 may include any suitable number of mirrors and motors that enable the optical system 20 to function as described herein. Further, the optical scanning device 42 may include any suitable scanning device that enables the optical system 20 to function as described herein, such as, for example, two-dimension (2D) scan galvanometers, three-dimension (3D) scan galvanometers, and dynamic focusing galvanometers.

The computing device 24 includes a computer system that includes at least one processor that executes executable instructions to operate the DMLM system 10. The computing device 24 includes, for example, a calibration model of the DMLM system 10 and an electronic computer build file associated with a component, such as the component 28. The calibration model includes, without limitation, an expected or desired melt pool size and temperature under a given set of operating conditions (e.g., a power of the laser device 14) of the DMLM system 10. The build file includes build parameters that are used to control one or more components of the DMLM system 10. Build parameters include, without limitation, a power of the laser device 14, a scan speed of the first laser scanning device 18, a position and orientation of the laser scanning device 18 (specifically, the mirror 34), a scan speed of the optical scanning device 42, and a position and orientation of the optical scanning device 42 (specifically, the first mirror 46 and the second mirror 50). In embodiments, the computing device 24 and the controller 26 are separate devices. In other embodiments, the computing device 24 and the controller 26 are combined as a single device that operates as both the computing device 24 and the controller 26 as each are described herein.

In embodiments, the computing device 24 is also configured to operate at least partially as a data acquisition device and to monitor the operation of the DMLM system 10 during fabrication of the component 28. In embodiments, the computing device 24 receives and processes the electrical signals 44 from the first optical detector 38. The computing device 24 stores information associated with the component 28 based on the electrical signals 44. The information is used to facilitate controlling and refining a build process for the DMLM system 10 or for a specific component built by the DMLM system 10.

Further, the computing device 24 is configured to adjust one or more build parameters in real-time based on the electrical signals 44 received from the first optical detector 38. For example, as the DMLM system 10 builds the component 28, the computing device 24 processes the electrical signals 44 from the first optical detector 38 using data processing algorithms to determine the size and location of portions of the component 28. The computing device 24 compares the size and location of portions of the component 28 to an expected or desired size and location of the component 28 based on a calibration model. The computing device 24 generates control signals 60 that are fed back to the controller 26 and used to adjust one or more build parameters in real-time to correct discrepancies in the size and location of the component 28.

The controller 26 includes any suitable type of controller that enables the DMLM system 10 to function as described herein. In embodiments, the controller 26 is a computer system that includes at least one processor and at least one memory device that executes executable instructions to control the operation of the DMLM system 10 based at least partially on instructions from human operators. The controller 26 includes, for example, a 3D model of the component 28 to be fabricated by the DMLM system 10. Executable instructions executed by the controller 26 include controlling the power output of the laser devices 14, 15, controlling a position and scan speed of the laser scanning devices 18, 19, and controlling a position and scan speed of the optical scanning device 42. The controller 26 is configured to control one or more components of the DMLM system 10 based on build parameters associated with a build file stored, for example, within the computing device 24. In embodiments, the controller 26 is configured to control the laser scanning device 18, 19 based on a build file associated with a component to be fabricated with the DMLM system 10. More specifically, the controller 26 is configured to control the position, movement, and scan speed of the mirror 34 using the motor 36 based upon a predetermined path defined by a build file associated with the component 28. The controller 26 is also configured to control other components of the DMLM system 10, including, for example, the laser devices 14, 15. In embodiments, the controller 26 controls the power output of the laser devices 14, 15 based on build parameters associated with a build file.

In embodiments, the controller 26 is also configured to control the optical scanning device 42 to direct electromagnetic radiation 40 from the melt pool 22 to the first optical detector 38. The controller 26 is configured to control the position, movement, and scan speed of the first mirror 46 and the second mirror 50 based on at least one of the position of the mirror 34 of the first laser scanning device 18 and the position of the melt pool 22. In embodiments, the position of the mirror 34 at a given time during the build process is determined, using the computing device 24 and/or the controller 26, based upon a predetermined path of a build file used to control the position of the mirror 34. The controller 26 controls the position, movement, and scan speed of the first mirror 46 and the second mirror 50 based upon the determined position of the mirror 34. In other embodiments, the laser scanning devices 18, 19 are configured to communicate the position of the mirror 34 to the controller 26 and/or the computing device 24, for example, by outputting position signals to the controller 26 and/or the computing device 24 that correspond to the position of the mirror 34. In other embodiments, the controller 26 controls the position, movement, and scan speed of the first mirror 46 and the second mirror 50 based on the position of the melt pool 22. The location of the melt pool 22 at a given time during the build process is determined, for example, based upon the position of the mirror 34.

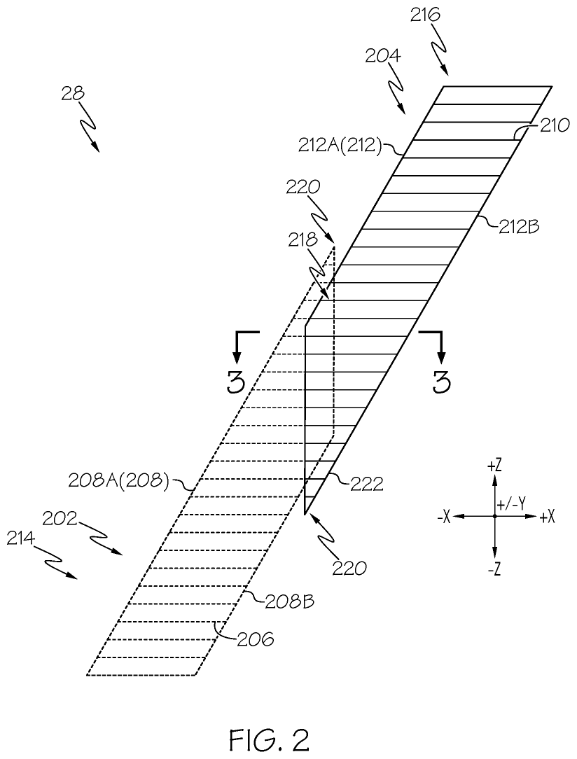

Referring now to FIG. 2, a side view of the solid component 28 formed from the powdered build material 21 (FIG. 1). The laser scanning device 18 (FIG. 1) directs the first laser beam 16 across the powdered build material 21 along a first set of laser beam paths 202 to form a first portion 214 of the solid component 28, and the second laser scanning device 19 (FIG. 1) directs the second laser beam 17 across the powdered build material 21 along a second set of laser beam paths 204 to form a second portion 216 of the solid component 28 partially above the first portion 214 of the solid component 28. For aid in distinguishing between the first portion 214 and the second portion 216 of the solid component 28, the first set of laser beam paths 202 are illustrated as dashed lines and the second set of laser beam paths 204 are illustrated as solid lines.

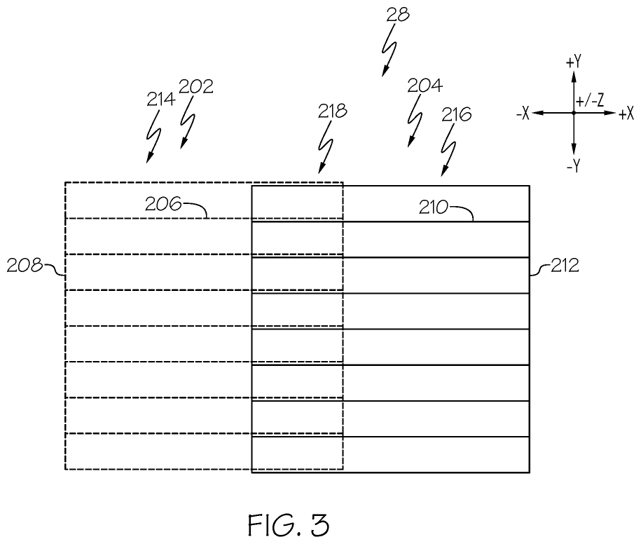

As shown in FIGS. 2 and 3, the first set of laser beam paths 202 includes a plurality of first hatching paths 206 and at least one first contour path 208, and the second set of laser beam paths 204 includes a plurality of second hatching paths 210 and at least one second contour path 212. In embodiments, the first contour path 208 defines an upper first contour path 208A and a lower first contour path 208B, collectively referred to herein as the first contour path(s) 208. Similarly, in embodiments, the second contour path 212 defines an upper second contour path 212A and a lower second contour path 212B, collectively referred to herein as the second contour path(s) 212. The hatching paths 206, 210 are laser beam paths within a solid portion of solid component 28 and the contour paths 208, 212 define end points of the hatching paths 206, 210 that follow the contour, or outer surface, of the solid component 28 across each layer of powdered build material 21 in the +Z direction. As depicted in FIG. 3, it should be appreciated that the contour paths 208, 212 and the hatching paths 206, 210 extend along the X axis of the coordinate axes depicted in the figures to form the solid component 28 in a layer by layer manner, as depicted in FIG. 2. Accordingly, the first laser beam 16 consolidates the first portion 214 of solid component 28 while second laser beam 17 consolidates the second portion 216 of solid component 28. However, it should be appreciated that the hatching paths 206, 210 forming each layer may extend in any direction along the X-Y plane such as along the Y axis, a plurality of hatching paths 206, 210 extending parallel to one another, or in a snake-shaped path so as to fill the contour paths 208, 212. Thus, the hatching paths 206, 210 need not extend between just two points in a linear direction. Additionally, the contour paths 208, 212 may include any number of offset contour paths 208, 212 offset from one another toward a center of the first portion 214 or the second portion 216 of the solid component. For example, two, three, or more than three contour paths 208, 212 may be provided, each offset from one another filing an interior of an adjacent contour path 208, 212, and the hatching paths 206, 210 filling a remaining portion of the contour paths 208, 212. Additionally, it should be appreciated that the first laser beam 16 and the second laser beam 17 only partially defines the first contour path 208 and the second contour path 212 across a path over a single layer of the powdered build material 21.

Referring still to FIGS. 2 and 3, the first hatching paths 206 and the second hatching paths 210 at least partially overlap each other in the Y direction in an overlapping region 218. Additionally, the first contour path 208 and the second contour path 212 also at least partially overlap each other in the Y direction and cooperate to define a boundary of the overlapping region 218. The overlapping region 218 seamlessly couples the first portion 214 of the solid component 28 to the second portion 216 of the solid component 28. As such, the overlapping region 218 enables the first laser beam 16 (FIG. 1) to manufacture the first portion 214 of the solid component 28 and the second laser beam 17 (FIG. 1) to manufacture the second portion 216 of the solid component 28. This is desirable in situations in which a single laser device would be ineffective at consolidating powdered build material across an entire area of a work surface such as when a range of the single laser device cannot reach an entire area of the work surface.

However, referring again to FIG. 2, in certain situations, the first laser scanning device 18 and second laser scanning device 19 (FIG. 1) may become misaligned such that the first contour path 208 of the first portion 214 of the solid component 28 and the second contour path 212 of the second portion 216 of the solid component 28 are misaligned in the X direction (i.e., offset from one another). This misalignment creates one or more steps or sharp corners 220, or sharp raised portions, on a contour 222 of the solid component 28 that is supposed to be continuous and smooth. As shown in FIG. 2, in embodiments, a pair of steps 220 are formed at a first surface of the component 28 and an opposite second surface of the component 28.

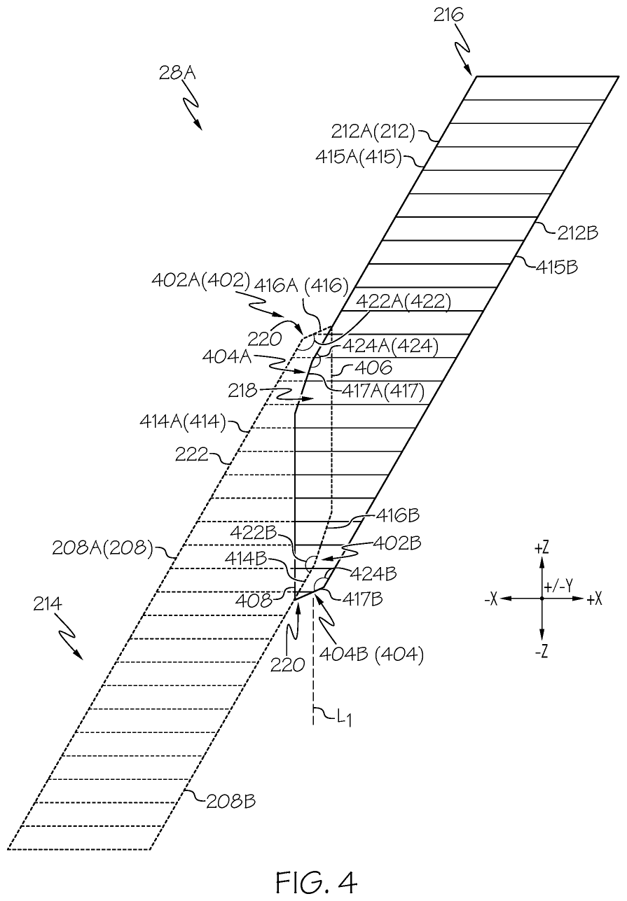

Referring now to FIG. 4, a side view of another solid component 28A formed from the powdered build material 21 (FIG. 1) is depicted. The solid component 28A is similar to the solid component 28 depicted in FIG. 2 and, thus, like reference numbers are used to refer to like parts. However, the solid component 28A differs from the solid component 28 depicted in FIG. 2 by including at least one first hook 402 formed near an end 406 of the first portion 214 of the solid component 28A at the overlapping region 218, and at least one second hook 404 formed near an end 408 of the second portion 216 of the solid component 28A at the overlapping region 218. As described herein, the first hook 402 and the second hook 404 are depicted as extending in the XZ plane. However, as described in more detail herein, it should be appreciated that hooks, either separate from or at least partially defining the first hook 402 and the second hook 404, may extend in the XY plane as well. As used herein a hook refers to a change in surface contour of a solid component from an adjacent portion of the surface contour so as to reduce a transition from the solid component to an adjacent solid component. As discussed in more detail herein, a hook may be formed across a plurality of layers extending along the Z axis and in the XZ plane of the solid component, such as when forming a vertical stitch. In other embodiments, a hook may be formed within a single layer extending along the Y axis and in the XY plane of the solid component. In other embodiments, as described herein, a hook may be formed across both of the XZ plane and the XY plane.

As shown in FIG. 4, the overlapping region 218 has a longitudinal axis L1 extending substantially parallel to the Z axis. As such, the embodiment depicted in FIG. 4 refers to a “vertical stitch”, as opposed to a horizontal stitch in which a longitudinal axis of the overlapping region 218 extends substantially parallel to the X axis, as discussed in more detail herein. Additionally, the first contour path 208 of the first portion 214 of the solid component 28A is misaligned from the second contour path 212 of the second portion 216 of the solid component 28A in the −X direction.

In embodiments, the at least one first hook 402 includes an upper first hook 402A and a lower first hook 402B, collectively referred to herein as the first hook(s) 402. The upper first hook 402A is formed at an intersection of the upper first contour path 208A and the end 406 of the first portion 214 of the solid component 28A, and the lower first hook 402B is formed at an intersection of the lower first contour path 208B and the end 406 of the first portion 214 of the solid component 28A. Similarly, in embodiments, the at least one second hook 404 includes an upper second hook 404A and a lower second hook 404B, collectively referred to herein as the second hook(s) 404. The upper second hook 404A is formed at an intersection of the upper second contour path 212A and the end 408 of the second portion 216 of the solid component 28A, and the lower second hook 404B is formed at an intersection of the lower second contour path 212B and the end 408 of the second portion 216 of the solid component 28A. The hooks 402, 404 reduce the sharpness of the step 220 and the contour 222 by stitching the first contour path 208 and the second contour path 212 together when a discontinuity is created by a misalignment within the contour 222 of the solid component 28A.

The first contour path 208 defines a first main portion 414 and a first hooked portion 416 cooperating to define the first hook 402. In embodiments in which the first portion 214 of the solid component 28A includes the upper first contour path 208A and the lower first contour path 208B, the upper first contour path 208A defines an upper first main portion 414A and an upper first hooked portion 416A to define the upper first hook 402A, and the lower first contour path 208B defines a lower first main portion 414B and a lower first hooked portion 416B to define the lower first hook 402B. Accordingly, it should be appreciated that the hooks 402 are defined by reducing a length of subsequent first hatching paths 206 in the +Z direction, thereby adjusting a position of the first contour path 208 formed at an end of the first hatching paths 206, as described herein.

Similarly, the second contour path 212 defines a second main portion 415 and a second hooked portion 417 cooperating to define the second hook 404. In embodiments in which the second portion 216 of the solid component 28A includes the upper second contour path 212A and the lower second contour path 212B, the upper second contour path 212A defines an upper second main portion 415A and an upper second hooked portion 417A to define the upper second hook 404A, and the lower second contour path 212B defines a lower second main portion 415B and a lower second hooked portion 417B to define the lower second hook 404B. As shown in FIG. 4, due to the misalignment between the upper first contour path 208A and the upper second contour path 212A, the upper first hooked portion 416A extends to contact the upper second contour path 212A. Similarly, the lower second hooked portion 417B extends to contact the lower first contour path 208B. Accordingly, it should be appreciated that the hooks 402 are defined by reducing a length of subsequent first hatching paths 206 in the −Z direction, thereby adjusting a position of the first contour path 208 formed at an end of the first hatching paths 206, as described herein.

The hooks 402, 404 reduce the sharpness of the step(s) 220 and the contour 222 by creating sloped surfaces extending from the end 406, 408 of first portion 214 and the second portion 216 of the solid component 28A. Accordingly, the hooks 402, 404 stitch together the first contour path 208 and the second contour path 212 when the first contour path 208 and the second contour path 212 are misaligned. Moreover, the hooks 402, 404 strengthen the interface between first portion 214 and second portion 216 of the solid component 28A.

As discussed herein, the hooks 402, 404 reduce the sharpness of the step(s) 220 and the contour 222 by creating a ramped or curved transition between the first contour path 208 and the second contour path 212. As depicted in FIG. 4, hooks 402, 404 define a ramped transition between the first contour path 208 and the second contour path 212. In doing so, the upper first hook 402A defines an upper first hook angle 422A between the upper first main portion 414A and the upper first hooked portion 416A. The lower first hook 402B defines a lower first hook angle 422B between the lower first main portion 414B and the lower first hooked portion 416B. The upper second hook 404A defines an upper second hook angle 424A between the upper second main portion 415A and the upper second hooked portion 417A. The lower second hook 404B defines a lower second hook angle 424B between the lower second main portion 415B and the lower second hooked portion 417B. As used herein, the upper first hook angle 422A, the lower first hook angle 422B, the upper second hook angle 424A, and the lower second hook angle 424B may collectively be referred to as the hook angles 422, 424 herein.

In embodiments, the hook angles 422, 424 include angles from about 0° to about 180°. In embodiments, the hook angles 422, 424 include angles from about 90° to about 180°. In embodiments, the hook angles 422, 424 include angles from about 100° to about 170°. In embodiments, the hook angles 422, 424 include angles from about 110° to about 160°. In embodiments, the hook angles 422, 424 include angles from about 120° to about 150°. In embodiments, the hook angles 422, 424 include angles from about 130° to about 140°. In embodiments, the hook angles 422, 424 include angles from about 120° to about 170°. However, it should be appreciated that the hook angles 422, 424 may include any angle that enables hooks 402, 404 to operate as described herein. The hook angles 422, 424 determine a sharpness of hooks 402, 404. A smaller hook angle 422, 424 reduces increases the sharpness of hooks 402, 404 as compared to larger hook angles 422, 424. More specifically, smaller hook angles 422, 424 intersect the other contour path 208, 212 closer to end 406, 408 of the first and second portions 214, 216 of the solid component 28A than larger hook angles 422, 424, and, as such, are sharper than hooks 402, 404 with larger hook angles 422, 424. Accordingly, varying the degree of the hook angles 422, 424 at least partially determines the sharpness of the hooks 402, 404.

As described herein, and with reference to FIGS. 1 and 4, the laser scanning device 18 directs the first laser beam 16 across the powdered build material 21 along the first hatching paths 206, the first contour path 208, and the first hook 402, and the laser scanning device 19 directs the second laser beam 17 across the powdered build material 21 along the second hatching paths 210, the second contour path 212, and the second hook 404. The hooks 402, 404 are formed along the first contour path 208 and the second contour path 212 proximate the end 406, 408 of the first and second portions 214, 216 of the solid component 28A and the length of the hooks 402, 404 is determined based on the particular hook angles 422, 424. Accordingly, the hooks 402, 404 reduce the sharpness and/or roughness of contour 222 that may occur due to potential misalignments of the laser devices 14, 15.

In another embodiment, referring still to FIGS. 1 and 4, the optical detector 38 detects a misalignment between the laser devices 14, 15 using any detection method that enables the optical detector 38 to operate as described herein, and the computing device 24 directs the controller 26 to add the hooks 402, 404 to the first contour path 208 and the second contour path 212 in response to detecting the misalignment. Specifically, the optical detector 38 detects the first contour path 208 and the second contour path 212 and determines whether the first contour path 208 and the second contour path 212 are misaligned. If so, the optical system 20 provides feedback to adjust the position of the laser beams 16, 17 to add the hooks 402, 404 to the first contour path 208 and the second contour path 212.

In other embodiments, the optical detector 38 detects a misalignment between the laser devices 14, 15, and the computing device 24 directs controller 26 to add one of the hooks 402, 404 to the first contour path 208 or the second contour path 212 when a misalignment occurs. Specifically, the optical detector 38 detects the first contour path 208 and the second contour path 212 and determines whether the first contour path 208 and the second contour path 212 are aligned as described above. However, rather than adding the hooks 402, 404 to the first contour path 208 and the second contour path 212, the computing device 24 processes the position of the first contour path 208 and the second contour path 212 to determine which contour path 208, 212 is the outer contour path and adds the hooks 402, 404 only to the outer contour path. In embodiments in which the first contour path 208 is the outer contour path, only the first hook 402 is added to first contour path 208. In other embodiments in which the second contour path 212 is the outer contour path, only the second hook 404 is added to second contour path 212.

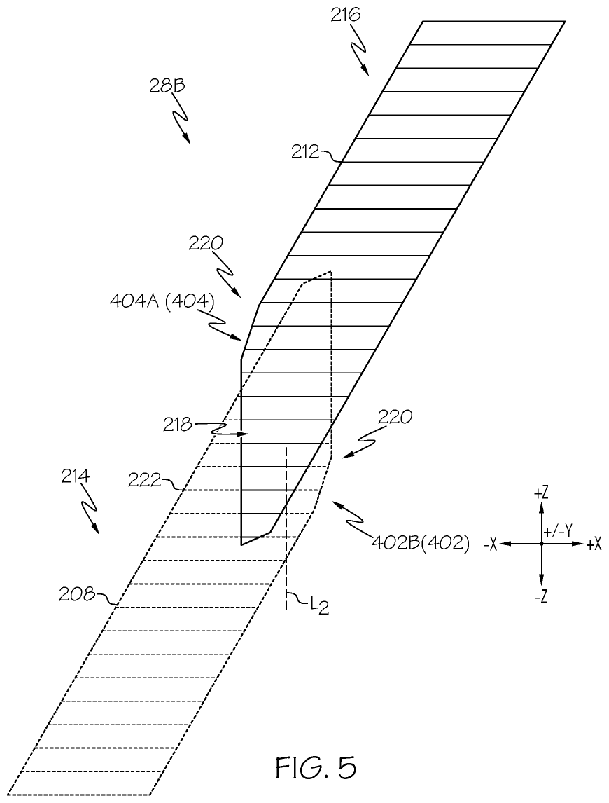

Referring now to FIG. 5, a side view of another solid component 28B formed from the powdered build material 21 (FIG. 1) is depicted. The solid component 28B is substantially similar to the solid component 28A and, thus, like reference numbers are used to refer to like parts. Specifically, the overlapping region 218 has a longitudinal axis L2 extending substantially parallel to the Z axis to provide the vertical stitch. However, the first contour path 208 of the first portion 214 of the solid component 28B is misaligned from the second contour path 212 of the second portion 216 of the solid component 28B in the +X direction rather than the −X direction as illustrated in the solid component 28A depicted in FIG. 4. Accordingly, despite the direction in which there is misalignment, the hooks 402, 404, particularly the lower first hook and the upper second hook, still reduce the sharpness of the step 220 and the contour 222.

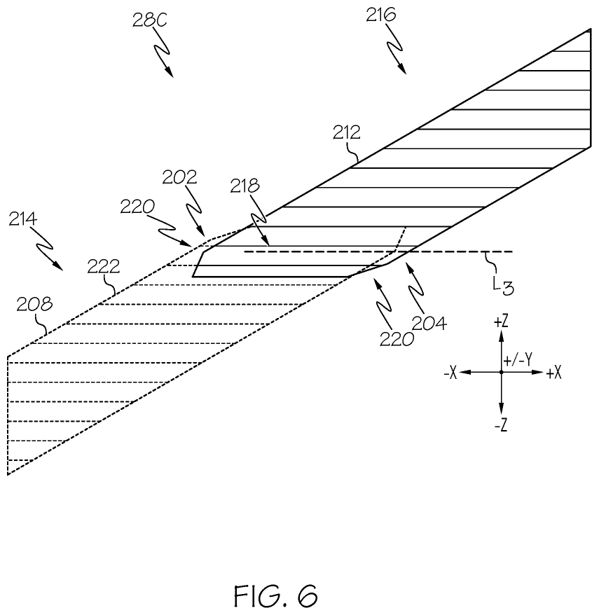

Referring now to FIG. 6, a side view of another solid component 28C formed from the powdered build material 21 (FIG. 1) is depicted. The solid component 28C is substantially similar to the solid component 28A and, thus, like reference numbers are used to refer to like parts. However, the overlapping region 218 has a longitudinal axis L3 extending substantially parallel to the X axis to provide a “horizontal stitch”, as opposed to the vertical stitch depicted in FIGS. 4 and 5. Additionally, similar to the solid component 28A depicted in FIG. 4, the first contour path 208 of the first portion 214 of the solid component 28B is misaligned from the second contour path 212 of the second portion 216 of the solid component 28B in the −X direction. The hooks 402, 404 reduce the sharpness of the steps 220 and the contour 222.

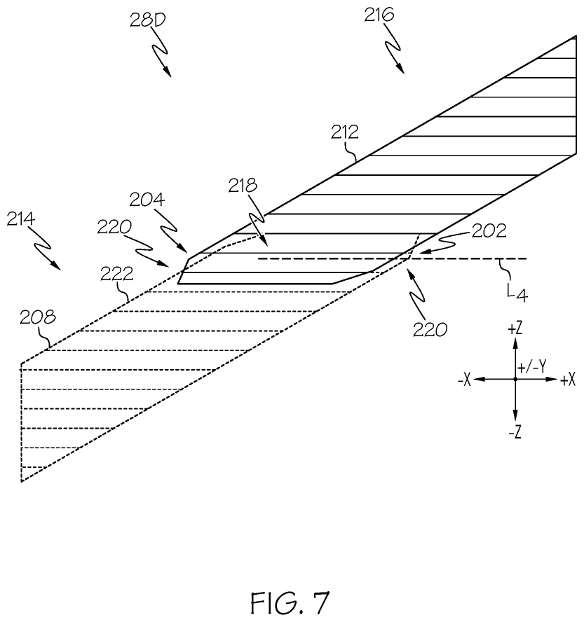

Referring now to FIG. 7, a side view of another solid component 28D formed from the powdered build material 21 (FIG. 1) is depicted. The solid component 28D is substantially similar to the solid component 28C and, thus, like reference numbers are used to refer to like parts. Specifically, the overlapping region 218 has a longitudinal axis L4 extending substantially parallel to the X axis to provide the horizontal stitch. However, the first contour path 208 of the first portion 214 of the solid component 28B is misaligned from the second contour path 212 of the second portion 216 of the solid component 28B in the +X direction rather than the −X direction as illustrated in the solid component 28C depicted in FIG. 6. Accordingly, despite the direction in which there is misalignment, the hooks 402, 404 still reduce the sharpness of the step 220 and the contour 222.

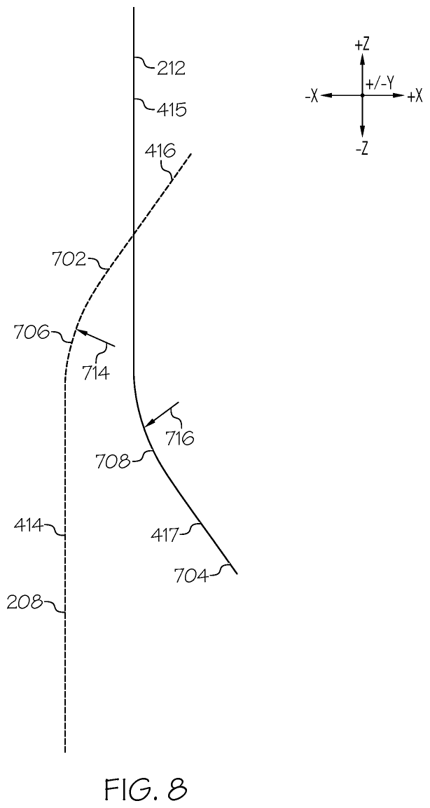

Referring now to FIG. 8, an enlarged view of the first contour path 208 including a first rounded hook 702 being misaligned with the second contour path 212 including a second rounded hook 704. It should be appreciated that the rounded hooks 702, 704 are similar to the hooks 402, 404 (FIG. 4) discussed herein. However, the rounded hooks 702, 704 formed in the contour paths 208, 212 include rounded portions 706, 708 provided between the main portions 414, 415 and the hooked portions 416, 417, as opposed to the hooked portions 416, 417 extending at the particular angles from the main portions 414, 415 described herein with reference to FIG. 4. As such, the rounded hooks 702, 704 form an arc of a circle proximate the intersection of main portions 414, 415 and the hooked portions 416, 417. Because rounded hooks 702, 704 are partially rounded rather than straight, the rounded hooks 702, 704 further reduce the sharpness and/or roughness of the contour 222 more than the hooks 402, 404. Although the rounded portions 706, 708 are described in more detail herein as being rounded when viewed in XY plane, as shown in FIG. 8, it should be appreciated that the rounded portions 706, 708 may be rounded in any other plane such as, for example, in the YZ plane and/or the XZ plane.

The first rounded portion 706 has a first rounded hook radius 714 and the second rounded portion 708 has a second rounded hook radius 716. In embodiments, the first rounded hook radius 714 and the second rounded hook radius 716 are about 0.01 millimeters (mm) to about 0.10 mm in length. However, the first rounded hook radius 714 and the second rounded hook radius 716 may be any length that enables the rounded hooks 702, 704 to operate as described herein. Additionally, in embodiments, the first rounded hook radius 714 and the second rounded hook radius 716 are equal. In other embodiments, the first rounded hook radius 714 and the second rounded hook radius 716 are different. The circular shape of rounded portions 706, 708 enable the laser beams 16, 17 (FIG. 1) to transition from the main portions 414, 415 to the hooked portions 416, 417 and for the transition time to be tuned. More specifically, the probability of an undesirable change in the melt pool, such as a keyhole, due a delay in transitioning from main portions 414, 415 to the hooked portions 416, 417 is reduced because the transition time is tuned. Additionally, the probability of the laser beams 16, 17 failing to follow the path of the hooked portions 416, 417 due a quick transition time is reduced because the transition time is tuned.

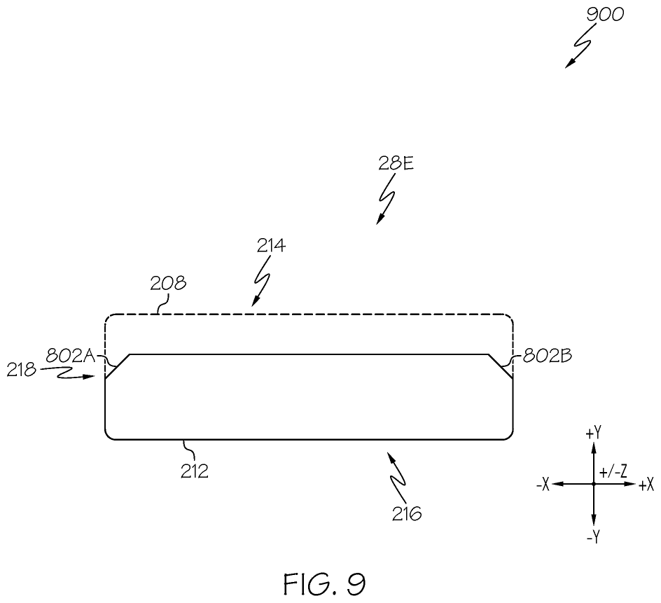

Referring now to FIG. 9, a top view of another solid component 28E formed from the powdered build material 21 (FIG. 1) is depicted. It should be appreciated that the solid component 28E is substantially similar to the solid component 28D and, thus, like reference numbers are used to refer to like parts. Specifically, the solid component 28E includes the first portion 214 and the second portion 216 overlapping at an overlapping region 218 extending in the XY plane. As shown in FIG. 9, a perimeter of the first portion 214 is defined by a first contour path 208, and a perimeter of the second portion 216 is defined by a second contour path 212. Although not depicted for ease of illustration, it should be appreciated that the first portion 214 and the second portion 216 are further formed by a plurality of hatching paths, as described herein with respect to the other embodiments, which fills the space between the first contour path 208 and the second contour path 212, respectively. Although only a single first contour path 208 and a single second contour path 212 is depicted, as described herein, a plurality of contour paths 208, 212 may be provided, each offset from one another toward a center in the XY plane. Hatching paths may then be provided to fill an interior of the inner most contour paths 208, 212.

As shown in FIG. 9, the second contour path 212 of the second portion 216 defines a pair of second hooks 802A, 802B extending inwardly from opposite ends of the second portion 216 in the +/−X directions. More specifically, the second hooks 802A, 802B taper inwardly from opposite sides of the second portion 216 by reducing a distance between the opposite sides of the second portion 216 as the laser beam forming the second portion 216 moves in the +Y direction. Accordingly, the second hooks 802A, 802B are formed at least in the XY plane, contrary to the hooks described herein that primarily extend in the XY plane. Thus, in situations in which the first contour path 208 of the first portion 214 of the solid component 28E is misaligned from the second contour path 212 of the second portion 216 of the solid component 28E in one or both of the +/−X directions and the +/−Y directions, the second hooks 802A, 802B reduce the sharpness between transition areas between the first portion 214 and the second portion 216 in the XY plane.

Although a pair of second hooks 802A, 802B are depicted, it should be appreciated that, in embodiments, only a single second hook may be provided. Alternatively, in other embodiments, more than a pair of second hooks may be provided. Additionally, although no hook is depicted in the first portion 214 of the solid component 28E, it should be appreciated that one or more hooks similar to the second hooks 802A, 802B may be formed at any suitable location of the first portion 214, such as within the overlapping region 218. It should also be appreciated that embodiments of a solid component may include any combination of hooks formed in the XZ plane, the XY plane, and/or a combination thereof based on the specific geometry of the solid component to be formed and the possible misalignment between the portions of the solid component.

More details regarding hooks extending in the XY plane may be found in U.S. Pat. No. 11,407,170, titled “System And Methods For Contour Stitching In Additive Manufacturing Systems” issued on Aug. 9, 2022, which is herein incorporated by reference in its entirety.

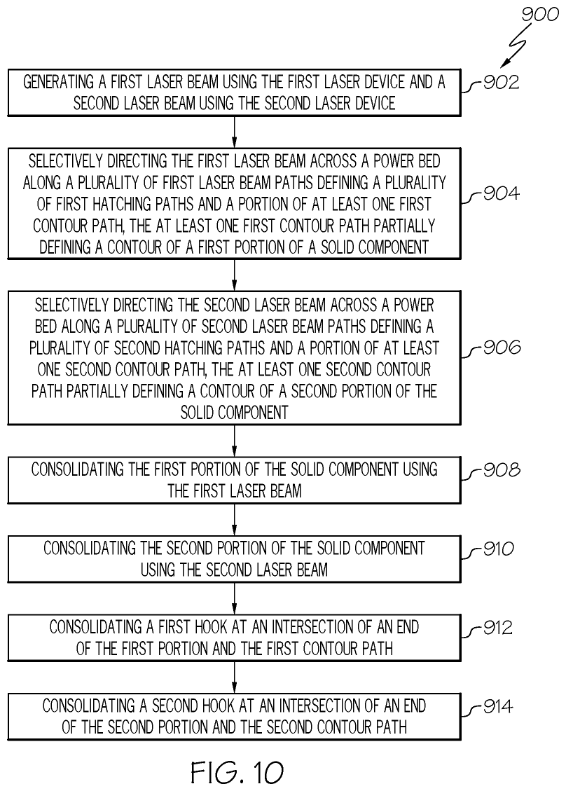

FIG. 10 depicts a method 900 for manufacturing a solid component with an additive manufacturing system, such as the DMLM system 10 depicted in FIG. 1. The additive manufacturing system includes at least two laser devices and at least two laser scanning devices. The at least two laser devices include a first laser device, such as the first laser device 14, and a second laser device, such as the second laser device 15. The at least two laser scanning devices include a first laser scanning device, such as the first laser scanning device 18, and a second laser scanning device. At step 902, a first laser beam is generated using the first laser device to form a first portion of a solid component, and a second laser beam is generated using the second laser device to form a second portion of the solid component. It should be appreciated that the first portion of the solid component is formed at least partially below the second portion of the solid component. Therefore, the first laser beam is generated prior to generating the second laser beam. However, the steps of the method 900 described herein may refer to an overlapping region of the solid component in which both the first portion and the second portion of the solid component are being simultaneously formed. Additionally, as noted above, the DMLM system 10 may include more than two laser devices to form respective portions of the solid component that overlap with one another and, as described herein, form hooks to at each overlapping region of the respective portions of the solid component to secure the portions to one another.

At step 904, the first laser beam is selectively directed across a powder bed along a first plurality of laser beam paths that define a plurality of first hatching paths and at least one first contour path using the first laser scanning device. The at least one first contour path partially defines a contour of the solid component. At step 906, the second laser beam is selectively directed across the powder bed along a second plurality of laser beam paths that define a plurality of second hatching paths and at least one second contour path using the second laser scanning device. The at least one second contour path partially defines the contour of the solid component. As described herein, the plurality of first and second contour paths are defined by one or more ends of the plurality of first and second hatching paths, respectively, across a plurality of layers extending along the Z axis forming the solid component. At step 908, the first portion of the solid component is consolidated using the first laser beam. At step 910, the second portion of the solid component is consolidated using the second laser beam. At step 912, a first hook is consolidated at an intersection of an end of the first portion and the first contour path. The first hook extends into the second contour path of the second portion. As described herein, the first hook may include a pair of first hooks such as, for example, an upper first hook and a lower first hook. In embodiments, as described herein, a detector, such as the optical detector 38, detects a misalignment between the laser devices and the first hook is consolidated in response to the misalignment being detected. In embodiments, the first hook is consolidated in response to further determining that the misalignment between the laser devices is greater than a predetermined offset threshold. Therefore, an optical system, such as the optical system 20, provides feedback to adjust a position of the laser beams to add the first hook to the first contour path.

Additionally, in embodiments, at step 914, a second hook is consolidated at an intersection of an end of the second portion and the second contour path. The second hook extends into the first contour path of the first portion. As described herein, the second hook may include a pair of second hooks such as, for example, an upper second hook and a lower second hook. It should be appreciated that the formation of the hooks may occur in any order based on an orientation and a misalignment of the first portion and the second portion of the solid component. For example, one or more of the second hooks may be formed before any one of the one or more first hooks. Similar to that described above with respect to step 912, in embodiments, the second hook is consolidated in response to the misalignment being detected. In embodiments, the second hook is consolidated in response to further determining that the misalignment between the laser devices is greater than a predetermined offset threshold, which may be different than the predetermined offset threshold discussed in step 912. Therefore, the optical system provides feedback to adjust a position of the laser beams to add the second hook to the second contour path.

From the above, it is to be appreciated that defined herein is an additive manufacturing system described herein that utilizes hooks formed at the end of contour paths to reduce the roughness of a contour of a solid component. The additive manufacturing system includes at least two laser devices and at least two laser scanning devices. The laser devices include a first laser device configured to generate a first laser beam and a second laser device configured to generate a second laser beam. The first laser beam is configured to consolidate a first portion of a solid component, and the second laser beam is configured to consolidate a second portion of the solid component. The laser scanning devices include a first laser scanning device and the second laser scanning device. The first laser scanning device is configured to direct the first laser beam from the first laser devices across a powder bed along a plurality of first laser beam paths defining a plurality of first hatching paths and a first contour path along a contour of the solid component. The second laser scanning device is configured to direct the second laser beam from the second laser device across the powder bed along a plurality of second laser beam paths defining a plurality of second hatching paths and at least one second contour path along the contour of the solid component. When the scanning devices become misaligned, the first contour path and the second contour path also become misaligned, creating a discontinuity on a surface of the solid component. The discontinuity causes roughness on the surface of the solid component. A hook is formed within the first and second contour paths in order to stitch the first and second portions of the solid component together and reduce the roughness caused by misalignment of the scanning devices and/or laser beams.

Further aspects of the embodiments described herein are provided by the subject matter of the following clauses:

Clause 1. An additive manufacturing system comprising: at least two laser devices comprising: a first laser device configured to generate a first laser beam for consolidating a first portion of a solid component; and a second laser device configured to generate a second laser beam for consolidating a second portion of the solid component; and at least two laser scanning devices comprising: a first laser scanning device configured to selectively direct the first laser beam across a powder bed along a first plurality of laser beam paths to define a plurality of first hatching paths and a portion of at least one first contour path, the at least one first contour path partially defining a contour of the first portion of the solid component; and a second laser scanning device configured to selectively direct the second laser beam across the powder bed along a second plurality of laser beam paths to define a plurality of second hatching paths and a portion of at least one second contour path, the at least one second contour path partially defining a contour of the second portion of the solid component, wherein the at least one first contour path defines a first hook extending along the contour of the first portion of the solid component into the at least one second contour path defining the contour of the second portion of the solid component.

Clause 2. The additive manufacturing system of any of the preceding claims, wherein the at least one second contour path includes a second hook extending along the contour of the second portion of the solid component into the at least one first contour path.

Clause 3. The additive manufacturing system of any of the preceding claims, wherein the plurality of first hatching paths at least partially overlap the plurality of second hatching paths.

Clause 4. The additive manufacturing system of any of the preceding claims, wherein the at least one first contour path at least partially overlaps the at least one second contour path.

Clause 5. The additive manufacturing system of any of the preceding claims, wherein the at least one first contour path and the at least one second contour path are at least partially misaligned.

Clause 6. The additive manufacturing system of any of the preceding claims, wherein the at least one first contour path includes an upper first contour path and a lower first contour path, the upper first contour path and the lower first contour path each including a first hook formed therein.

Clause 7. The additive manufacturing system of any of the preceding claims, wherein the at least one second contour path includes an upper second contour path and a lower second contour path, the upper second contour path and the lower second contour path each including a second hook formed therein.

Clause 8. The additive manufacturing system of any of the preceding claims, wherein the first hook defines a first main portion and a first hooked portion.

Clause 9. The additive manufacturing system of any of the preceding claims, wherein the first hook defines a first hook angle between the first main portion and the first hooked portion, the first hook angle is equal to or greater than 120° and less than or equal to 170°.

Clause 10. The additive manufacturing system of any of the preceding claims, further comprising: an optical detector detecting a misalignment between the first laser device and the second laser device; and a controller configured to operate the first laser scanning device to form the first hook in response to the optical detector detecting the misalignment.

Clause 11. A method for manufacturing a solid component with an additive manufacturing system, the additive manufacturing system including at least two laser devices and at least two laser scanning devices, the at least two laser devices including a first laser device and a second laser device, the at least two laser scanning devices including a first laser scanning device and a second laser scanning device, the method comprising: generating a first laser beam using the first laser device and a second laser beam using the second laser device; selectively directing, by using the first laser scanning device, the first laser beam across a powder bed along a first plurality of laser beam paths to define a plurality of first hatching paths and a portion of at least one first contour path, the at least one first contour path partially defining a contour of a first portion of the solid component; selectively directing, by using the second laser scanning device, the second laser beam across the powder bed along a second plurality of laser beam paths to define a plurality of second hatching paths and a portion of at least one second contour path, the at least one second contour path partially defining a contour of a second portion of the solid component; consolidating the first portion of the solid component using the first laser beam; and consolidating the second portion of the solid component using the second laser beam, wherein the at least one first contour path defines a first hook extending along the contour of the first portion of the solid component into the at least one second contour path defining the contour of the second portion of the solid component.

Clause 12. The method of any of the preceding claims, wherein the first hook is formed at an intersection of an end of the first portion and the at least one first contour path.

Clause 13. The method of any of the preceding claims, wherein the at least one second contour path defines a second hook extending along the contour of the second portion of the solid component into the at least one first contour path, the second hook is formed at an intersection of an end of the second portion and the at least one second contour path.

Clause 14. The method of any of the preceding claims, wherein the plurality of first hatching paths at least partially overlap the plurality of second hatching paths.

Clause 15. The method of any of the preceding claims, wherein the at least one first contour path at least partially overlaps the at least one second contour path.

Clause 16. The method of any of the preceding claims, wherein the at least one first contour path and the at least one second contour path are at least partially misaligned.

Clause 17. The method of any of the preceding claims, wherein the at least one first contour path includes an upper first contour path and a lower first contour path, the upper first contour path and the lower first contour path each including a first hook formed therein.

Clause 18. The method of any of the preceding claims, wherein the at least one second contour path includes an upper second contour path and a lower second contour path, the upper second contour path and the lower second contour path each including a second hook formed therein.

Clause 19. The method of any of the preceding claims, wherein the first hook defines a first main portion and a first hooked portion, wherein the first hook defines a first hook angle between the first main portion and the first hooked portion, the first hook angle is equal to or greater than 120° and less than or equal to 170°.

Clause 20. The method of any of the preceding claims, further comprising: detecting a misalignment between the at least two laser devices; and forming the first hook in the first portion of the solid component in response to detecting the misalignment.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An additive manufacturing system comprising:
at least two laser devices comprising:
a first laser device configured to generate a first laser beam for consolidating a first portion of a solid component; and
a second laser device configured to generate a second laser beam for consolidating a second portion of the solid component; and
at least two laser scanning devices comprising:
a first laser scanning device configured to selectively direct the first laser beam across a powder bed along a first plurality of laser beam paths to define a plurality of first hatching paths and a portion of at least one first contour path, the at least one first contour path partially defining a contour of the first portion of the solid component; and
a second laser scanning device configured to selectively direct the second laser beam across the powder bed along a second plurality of laser beam paths to define a plurality of second hatching paths and a portion of at least one second contour path, the at least one second contour path partially defining a contour of the second portion of the solid component,
wherein the at least one first contour path defines a first hook extending along the contour of the first portion of the solid component into the at least one second contour path defining the contour of the second portion of the solid component.

2. The additive manufacturing system of claim 1, wherein the at least one second contour path includes a second hook extending along the contour of the second portion of the solid component into the at least one first contour path.

3. The additive manufacturing system of claim 1, wherein the plurality of first hatching paths at least partially overlap the plurality of second hatching paths.

4. The additive manufacturing system of claim 1, wherein the at least one first contour path at least partially overlaps the at least one second contour path.

5. The additive manufacturing system of claim 4, wherein the at least one first contour path and the at least one second contour path are at least partially misaligned.

6. The additive manufacturing system of claim 2, wherein the at least one first contour path includes an upper first contour path and a lower first contour path, the upper first contour path and the lower first contour path each including a first hook formed therein.

7. The additive manufacturing system of claim 6, wherein the at least one second contour path includes an upper second contour path and a lower second contour path, the upper second contour path and the lower second contour path each including a second hook formed therein.

8. The additive manufacturing system of claim 1, wherein the first hook defines a first main portion and a first hooked portion.

9. The additive manufacturing system of claim 8, wherein the first hook defines a first hook angle between the first main portion and the first hooked portion, the first hook angle is equal to or greater than 120° and less than or equal to 170°.

10. The additive manufacturing system of claim 1, further comprising:
an optical detector detecting a misalignment between the first laser device and the second laser device; and
a controller configured to operate the first laser scanning device to form the first hook in response to the optical detector detecting the misalignment.

11. A method for manufacturing a solid component with an additive manufacturing system, the additive manufacturing system including at least two laser devices and at least two laser scanning devices, the at least two laser devices including a first laser device and a second laser device, the at least two laser scanning devices including a first laser scanning device and a second laser scanning device, the method comprising:
generating a first laser beam using the first laser device and a second laser beam using the second laser device;
selectively directing, by using the first laser scanning device, the first laser beam across a powder bed along a first plurality of laser beam paths to define a plurality of first hatching paths and a portion of at least one first contour path, the at least one first contour path partially defining a contour of a first portion of the solid component;
selectively directing, by using the second laser scanning device, the second laser beam across the powder bed along a second plurality of laser beam paths to define a plurality of second hatching paths and a portion of at least one second contour path, the at least one second contour path partially defining a contour of a second portion of the solid component;
consolidating the first portion of the solid component using the first laser beam; and
consolidating the second portion of the solid component using the second laser beam,
wherein the at least one first contour path defines a first hook extending along the contour of the first portion of the solid component into the at least one second contour path defining the contour of the second portion of the solid component.

12. The method of claim 11, wherein the first hook is formed at an intersection of an end of the first portion and the at least one first contour path.

13. The method of claim 11, wherein the at least one second contour path defines a second hook extending along the contour of the second portion of the solid component into the at least one first contour path, the second hook is formed at an intersection of an end of the second portion and the at least one second contour path.

14. The method of claim 11, wherein the plurality of first hatching paths at least partially overlap the plurality of second hatching paths.

15. The method of claim 11, wherein the at least one first contour path at least partially overlaps the at least one second contour path.

16. The method of claim 15, wherein the at least one first contour path and the at least one second contour path are at least partially misaligned.

17. The method of claim 11, wherein the at least one first contour path includes an upper first contour path and a lower first contour path, the upper first contour path and the lower first contour path each including a first hook formed therein.

18. The method of claim 11, wherein the at least one second contour path includes an upper second contour path and a lower second contour path, the upper second contour path and the lower second contour path each including a second hook formed therein.

19. The method of claim 11, wherein the first hook defines a first main portion and a first hooked portion, wherein the first hook defines a first hook angle between the first main portion and the first hooked portion, the first hook angle is equal to or greater than 120° and less than or equal to 170°.

20. The method of claim 11, further comprising:
detecting a misalignment between the at least two laser devices; and
forming the first hook in the first portion of the solid component in response to detecting the misalignment.
